(19) United States
(12) Patent Application Publication
(10) Pub. No.: US 2015/0013083 A1
(43) Pub. Date: Jan. 15, 2015

(54) Centralized Air Supply Loading Dock Leveling System

(71) Applicant: Systems, Inc., Germantown, WI (US)

(72) Inventor: Gerard Martin Palmersheim, Hubertus, WI (US)

(21) Appl. No.: 14/502,637

(22) Filed: Sep. 30, 2014

Related U.S. Application Data
(63) Continuation-in-part of application No. 13/742,345, filed on Jan. 15, 2013.
Application No. 13/742,345 is a continuation-in-part of application No. 13/325,059, filed on Dec. 14, 2011, now Pat. No. 8,627,529.

(51) Int. Cl. B65G 69/28

(52) U.S. Cl. CPC B65G 69/2817
USPC 14/71.3

(57) ABSTRACT

A dock leveler includes an inflatable bellows to which pressurized air is selectively coupled. The inflatable bellows is arranged to raise and lower a distal portion of a loading dock ramp in response to the degree to which the inflatable bellows is inflated with compressed air. A control valve is coupled to the inflatable bellows, where the control valve is arranged to selectively release compressed air from the inflatable bellows in response to an operator action that is (for example) intended to lower the ramp. An exhaust manifold is arranged to receive the selectively released air from the control valve and to directionally exhaust a focused stream of compressed air underneath the ramp so that the compressed air is directed to move debris towards the distal portion of the ramp to facilitate cleaning of the loading dock pit that lies underneath the ramp. A solar power subsystem stores solar energy to power a compressor that provides the compressed air.

### CLAIM OF PRIORITY

This application for patent is a continuation-in-part of and claims priority to U.S. application Ser. No. 13/742,345, filed Jan. 15, 2013 entitled “Centralized Air Supply Loading Dock Leveling System;” which is a continuation-in-part of U.S. application Ser. No. 13/325,059, filed Dec. 14, 2011 entitled “Centralized Air Supply Loading Dock Leveling System,” now U.S. Pat. No. 8,627,529, wherein the applications listed above are incorporated by reference herein for all purposes.

### BACKGROUND

Loading docks include dock levelers that are used to provide a loading dock ramp such as a dock board to accommodate varying distances in height between a loading dock and a vehicle from which cargo is to be loaded or unloaded. Conventionally, mechanical, hydraulic, and pneumatic dock leveler systems are used to pivot the ramp to accommodate the varying distances. For example, a conventional pneumatic dock leveler uses an inflatable member or airbag to raise and lower the ramp. Such dock leveler systems are disclosed in U.S. Pat. No. 6,360,393, which is hereby incorporated by reference in its entirety.

While the use of pneumatic components in loading dock systems has simplified maintenance and operational requirements in loading dock systems, the pneumatic components still often require maintenance that can result in costly downtime of the loading docks. For example, conventional pneumatic loading dock levelers include a blower and an inflatable member such as an airbag, both of which are typically located beneath the loading dock ramp of the dock leveler. Maintenance of the components is difficult because accessing the “hidden” components often requires removal of the loading dock ramp, which results in “downtime” of the dock leveler.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

A system and method is disclosed herein for providing a centralized pressurized air supply for pivoting a loading dock ramp by selectively inflating an inflatable member of an inflatable lifting assembly. The central pressurized air supply includes a blower and/or pressurized air vessel that is located in an easily accessible central (or centralized) location and that is arranged to selectively couple pressurized air to one or more dock levelers via a compressed air distribution system. Each dock leveler includes an inflatable member to which the pressurized air is selectively coupled, and the inflatable member is arranged to raise and lower one end of the loading dock ramp of a dock leveler.

These and other features and advantages will be apparent from a reading of the following detailed description and a review of the associated drawings. It is to be understood that both the foregoing general description and the following detailed description are explanatory only and are not restrictive. Among other things, the various embodiments described herein may be embodied as methods, devices, or a combination thereof. The disclosure herein is, therefore, not to be taken in a limiting sense.

### BRIEF DESCRIPTION OF THE FIGURES

FIG. 1 is an isometric view illustrating an embodiment of a centralized air supply dock leveling system.

FIG. 2 is an isometric view of an embodiment of centralized air supply dock leveling system in a built-in configuration.

FIG. 3 is a schematic diagram illustrating an embodiment of a centralized air supply dock leveling system.

FIG. 4 is a schematic diagram illustrating an embodiment of a pneumatic edge-of-dock leveler of a dock leveling system.

FIG. 5 is a schematic diagram illustrating an embodiment of a distributed reservoir of a centralized air supply dock leveling system.

FIG. 6 is a frontal isometric view illustrating an embodiment of a self-cleaning dock leveling system frame.

FIG. 7 is a frontal isometric view illustrating an embodiment of a self-cleaning dock leveling frame and system.

FIG. 8 is a rear isometric view illustrating an embodiment of a self-cleaning dock leveling frame and system.

FIG. 9 is a rear isometric view illustrating operation of a self-cleaning dock leveling frame and system.

FIG. 10 is a functional block diagram generally illustrating operative components of a solar powered subsystem for the dock leveling system of FIG. 1.

FIG. 11 is a diagram generally illustrating a solar panel array that may be used in connection with the solar powered subsystem shown in FIG. 10.

FIGS. 12 and 13 are charts showing design considerations for the preferred solar powered subsystem which makes use of an alternate back up powered pressure source.

### DETAILED DESCRIPTION

Various embodiments will be described in detail with reference to the drawings, wherein like reference numerals represent like parts and assemblies throughout the several views. Many details of certain embodiments of the disclosure are set forth in the following description and accompanying figures so as to provide a thorough understanding of the embodiments. Reference to various embodiments does not limit the scope of the claims attached hereto. Additionally, any examples set forth in this specification are not intended to be limiting and merely set forth some of the many possible embodiments for the appended claims.

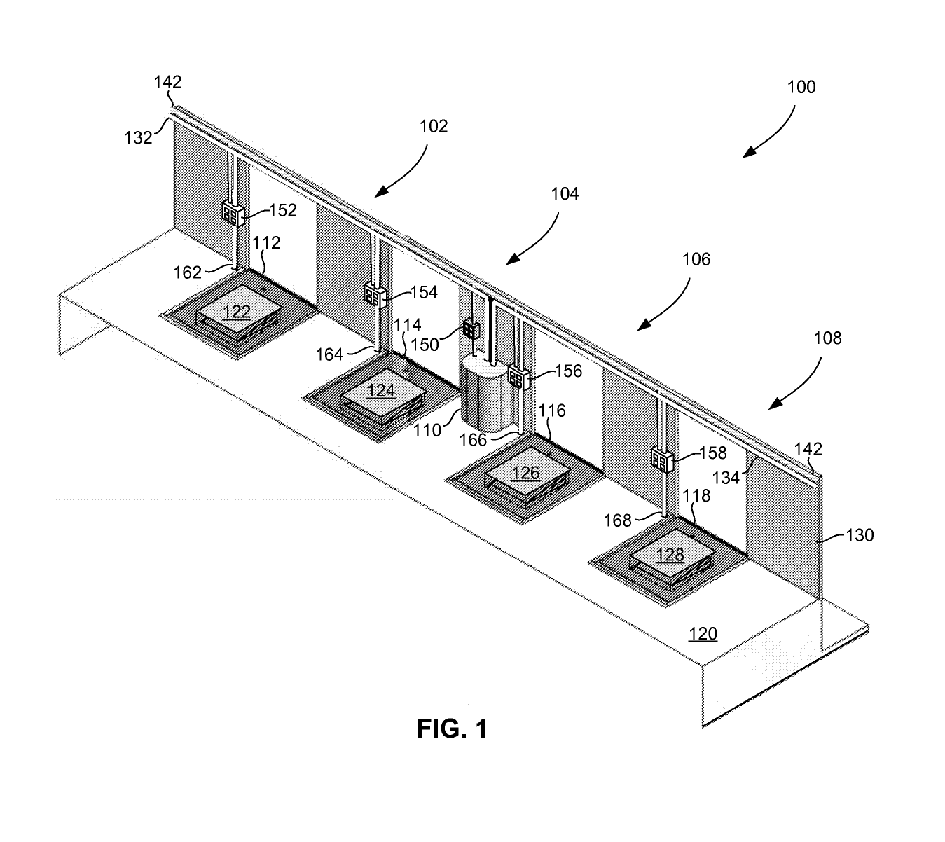

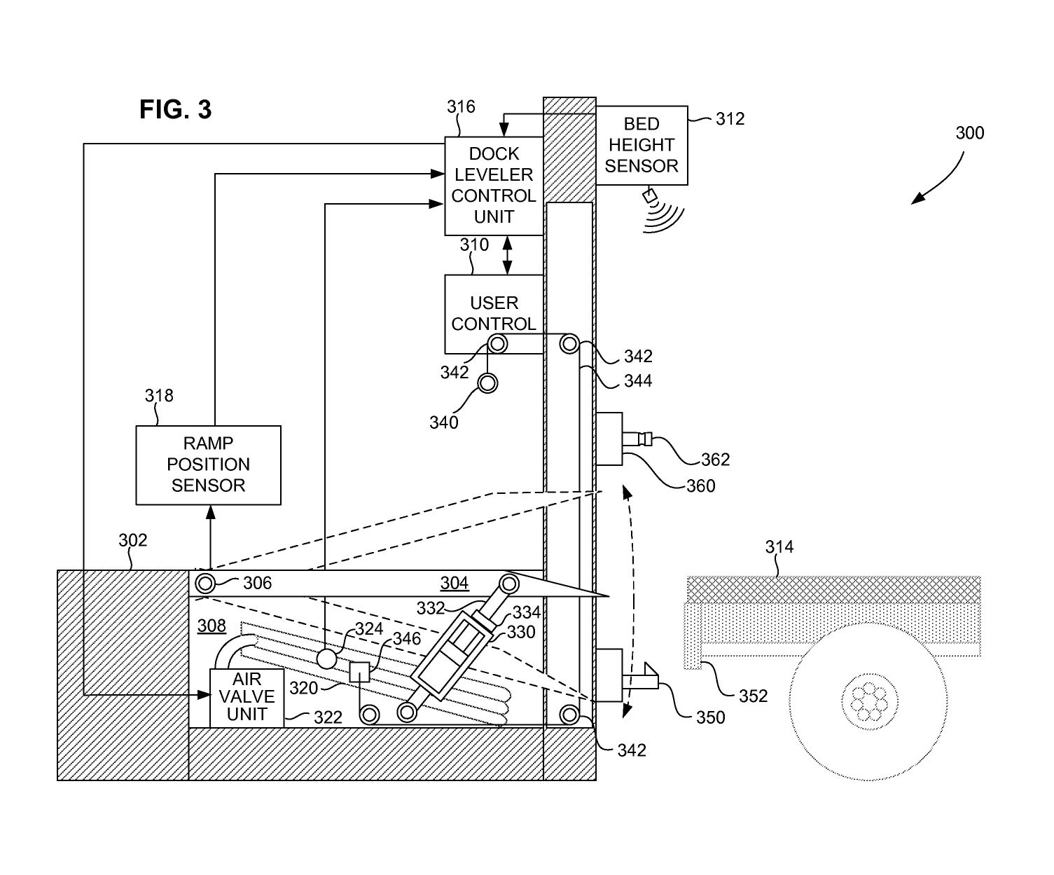

FIG. 1 is an isometric view illustrating an embodiment of a centralized air supply dock leveling system. The dock leveling system 100 includes a loading dock 120 in which bay 102, bay 104, bay 106, and bay 108 are arranged. Bay 102 includes a loading dock ramp 112 that is hinged (e.g. rotatably coupled) at a proximal edge (see, for example, ramp 304 in FIG. 3). An inflatable bag (such as an airbag, inflatable bellows, balloon, bladder, expansive chamber, pneumatic cylinder, and the like) 122 is arranged in a pit underneath ramp 112 so as to raise and lower a distal edge of ramp 112. A local control box 152 is provided to provide control for an operator standing adjacent to the ramp 112 to raise or lower the distal edge of the ramp 112.

Likewise, bay 104 includes a loading dock ramp 114 that is hinged at a proximal edge with an inflatable bag 124 arranged beneath ramp 114 so as to raise and lower a distal edge of ramp 114 using a local control box 154 to raise or lower the distal edge of the ramp 114; bay 106 includes a loading dock ramp 116 that is hinged at a proximal edge with an inflatable bag 126 arranged beneath ramp 116 so as to raise and lower a distal edge of ramp 116 using a local control box 156 to raise or lower the distal edge of the ramp 116; and bay 108 includes a loading dock ramp 118 that is hinged at a proximal edge with an inflatable bag 128 arranged beneath ramp 118 so as to raise and lower a distal edge of ramp 118 using a local control box 158 to raise or lower the distal edge of the ramp 118. More (or less) bays can be included (or excluded) depending on the loading dock “throughput” that is needed or anticipated by a business operating the loading dock.

The dock leveling system 100 also includes a centralized air supply 110 that is coupled to control boxes 152 and 154 via air line 132 and coupled to control 156 and 158 via air line 134. Air lines 132 and 134 can be (for example) connected to each other or coupled to a common pressure chamber (e.g., air tank) using check-valves so that a loss of air pressure in one line does not affect the second air line.

Control box 152 is a local control box that selectively couples air line 132 to air line 162, which in turn is coupled to inflatable bag 122. Control box 154 is a local control box that selectively couples air line 132 to air line 164, which in turn is coupled to inflatable bag 124. Control boxes 152 and 154 are thus arranged to respectively control the inflation of inflatable bags 122 and 124.

Control box 156 is a local control box that selectively couples air line 134 to air line 166, which in turn is coupled to inflatable bag 126. Control box 158 selectively couples air line 134 to air line 168, which in turn is coupled to inflatable bag 128. Control boxes 156 and 158 are thus arranged to respectively control the inflation of inflatable bags 126 and 128.

In operation (for example), a user standing adjacent to ramp 112 can depress a button on control box 152 to raise (or lower) the distal portion of ramp 112. When the appropriate button is pressed to raise the ramp (such as before a truck backs closely into the bay 102), a valve in control box 152 (or in the alternative, the valve may be located elsewhere) opens to couple pressurized air from the centralized air supply 110 to the inflatable bag 122, which further inflates the inflatable bag 122 and thus raises the distal portion of ramp 112. Air is then transferred in accordance with a pressure gradient from the centralized air supply 110 (which is replenished by a compressor or other source of pressurized air that is inside of or coupled to the centralized air supply 110) to the inflatable bag 122.

When the inflation button is released, the valve to air line 162 closes, which seals pressurized air in the inflatable bag 122 (irrespective of subsequent pressure changes in air line 132). The user can depress a “lock” button on the control box 152 that helps to maintain air pressure (due to leaks, for example) in the inflatable bad 122 by evaluating a pressure sensor reading (such as pressure sensor 324 shown in FIG. 3) and automatically actuating the valve to air line 162 to raise the pressure to the level at which the pressure was at the time the lock button was pressed.

The distal portion of ramp 112 can be lowered in response to a user depressing a “lower ramp” button, which allows pressurized air to escape from the inflatable bag 122 via a selectively controlled pressure release valve (not shown). The ramp is lowered until the user releases the “lower ramp” button, which closes the pressure release valve. (In an exemplary alternative embodiment, the ramp can be raised by depressing an “inflate bellows” button, whereas the ramp can be lowered by releasing the “inflate bellows” button (wherein the release of the “inflate bellows” opens a control valve that is arranged to vent the compressed air of the inflated bellows to atmosphere by operation of gravity forces exerted on the ramp).

Thus, the user can selectively raise the distal portion of the ramp 112 above the level of a truck bed to be docked at the bay 102, wait until the truck bed is suitably positioned (such as when a rear edge of the truck bed extends inwards from the distal edge of the ramp 112), and press the “lower ramp” button until a distal portion of ramp 112 contacts the bed of the truck. The variable-height ramp 112 allows the contents of the truck bed to unloaded from the truck bed without materiel handlers having to negotiate a step formed by differing levels of the loading dock 120 and the truck bed.

After unloading is finished, the ramp can be raised by the user pressing the “raise ramp” button, to allow the truck to depart free of the ramp 112. After the truck has departed, the user can press the “lower ramp” button to return the ramp 112 to a neutral position that is level with the surface of loading dock 120. (Further modes of operation are discussed with respect to FIG. 3 below.)

Master control box 150 is a master control box that is arranged to coordinate functions of each of the (local) control boxes 152, 154, 156, and 158. The master control box 150 is coupled to each of the control boxes 152, 154, 156, and 158 via control lines 142. Thus, each of the inflatable air bags 122, 124, 126, and 128 can be inflated under the control of the respective local control box and/or under the control of the master control box 150. Further, the master control box 150 can be arranged to apply (“turn on”) or remove (“turn off”) power from the dock leveling system 100. Master control box 150 can be coupled to the centralized air supply 110 to control, for example, turning a compressor coupled to a pressure chamber “on” or “off,” setting a pressure limit at which the compressor automatically turns off, setting a power saving mode, and the like. The functions of master control box can be implemented within a local control box, which eliminates the need for a separate housing for the control box.

The functions of master control box 150 also include the ability to arbitrate commands from each of the local control boxes (such as when “raise ramp” buttons from multiple control boxes are nearly simultaneously depressed). For example, when faster inflation of an inflatable bag is desired (such as when operating in a low power mode), priority can be given to the button that was pushed first (or in the alternative, the last-pushed button) so that stored pressurized air can be delivered to the inflatable bag to the bay that is assigned priority. Likewise, the master control box 150 can direct the compressor, for example, to increase the rate at which the pressurized air is supplied and/or produced when multiple “raise ramp” buttons are pressed simultaneously (or nearly simultaneously).

The components of dock leveling system 100 are arranged to be easily installed as, for example, an upgrade kit that is used to upgrade from a (relatively environmentally unfriendly) hydraulically actuated system to a (more environmentally friendly) pneumatically actuated system. For example, the master control box 150 and the centralized air supply 110 can be arranged in a central location between bay doors. Control lines 142 and air lines 132 and 134 care routed over the bay doors. The inflatable bags (e.g., inflatable bag 122) can be relatively easily placed in the pit beneath each ramp (e.g., ramp 112) when the ramp is removed for maintenance. Likewise, the selectively coupled air line (e.g., air line 162) can be routed through a portion of the loading dock 120 surface (e.g., adjacent to the bay door and the ramp pit) that is relatively easily evacuated with hand tools. Thus, no control lines and air lines lie on an exposed horizontal surface, where the integrity of the lines could be compromised by foot or hand truck traffic, for example.

Additionally, a local control box (such as control box 156) can include the functionality and controls of the master control box 150 to minimize the number of components installed. Likewise, a valve can be fitted with each local control box to minimize component counts and simplify installation.

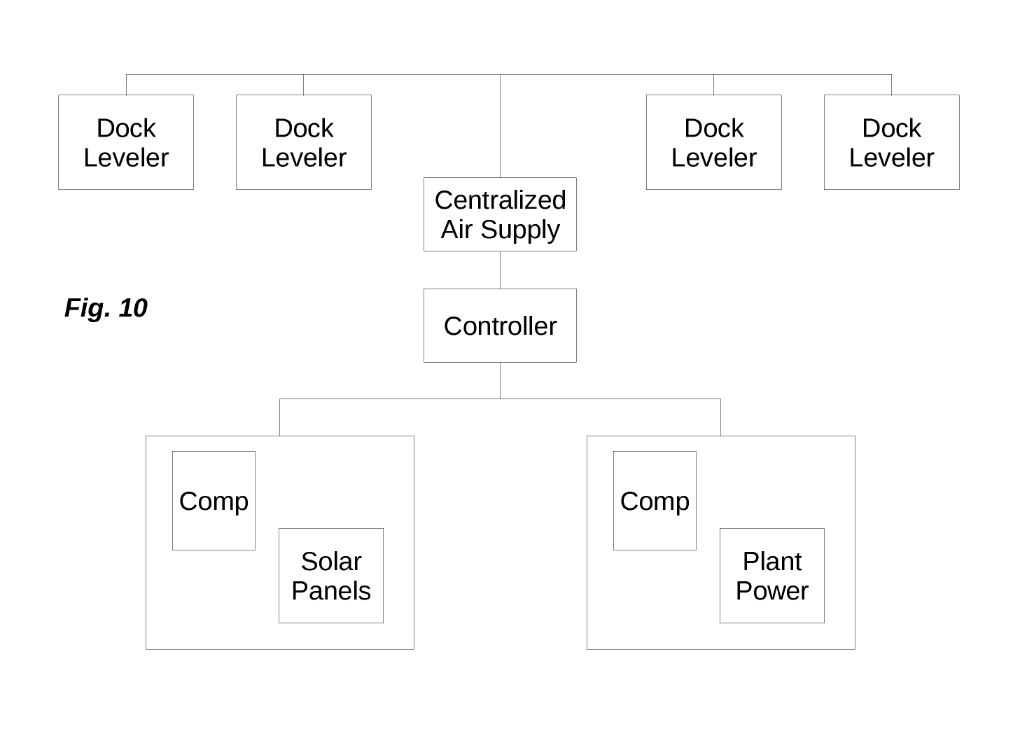

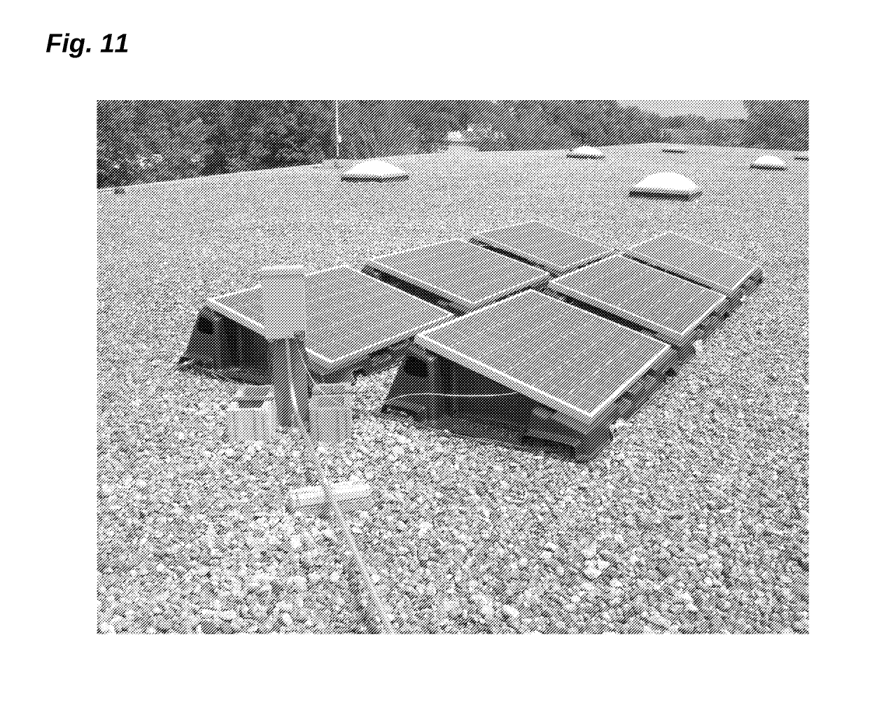

In this embodiment, an energy-efficient power subsystem may be used to maintain air pressure in the centralized air supply 110. Referring briefly to FIG. 10, the centralized air supply 110 may be replenished preferably using a first compressor powered by an array of solar panels. The solar panel array (described below in conjunction with FIG. 11) is designed and configured to store and provide sufficient power such that the solar power system can maintain a first pressure in the central air supply 110. For instance, the solar power subsystem may be configured to maintain the central air supply 110 at roughly 150 psi.

Additionally, and in recognition that solar power is not always available (such as on cloudy days or during stormy weather), a plant power subsystem is provided as a backup to the solar power subsystem. A controller monitors the pressure in the central air supply 110 to detect when the pressure falls below some threshold, such as 90 psi, thereby indicating that the solar power subsystem is unable, for whatever reason, to maintain an appropriate amount of pressure in the central air supply 110. Such a condition may, and likely does, indicate that the solar panel array was unable to store sufficient power to run the first compressor adequately. Therefore, rather than allow the central air supply 110 to become depleted, the controller activates a plant power subsystem, which operates as a backup air pressure supply. When activated, the plant power subsystem uses an alternate power source, such as ordinary A/C power, to run a backup compressor and bring the central air supply 110 up to an adequate pressure. In this manner, solar power may be used to operate the dock leveling system 100 under conditions in which solar power is sufficient, thereby conserving plant energy. And in any conditions in which solar power is insufficient, less efficient plant power may be used to ensure that the dock leveling system 100 does not cease adequate operability.

Referring briefly to FIG. 11, the solar panel array may preferably be composed of six two-hundred watt solar panels mounted to six ballasted roof mount supports. The solar panel array is preferably wired so there are three parallel strings of two solar collectors (six panels). In this embodiment, the solar panel array is capable of producing 88 volts DC at 15 amps. A combiner panel is located at the end of the array allowing for simple panel wire terminations. Fusing for each string of panels may also be provided within the combiner panel. The combiner panel may be wired using two wires (gage based on distance) and an external ground.

The solar panels may also be attached to individual molded mounting trays. Four captive bolts can be used to fasten each of the solar panels to its mounting tray. The mounting trays may be ballasted, such as with three half-solid concrete blocks each weighing roughly 35 lbs. An alternative to the concrete block may be roof aggregate. The molded trays could be fastened together. The mounting trays preferably weigh roughly nineteen pounds each and are made from chlorine-free polyethylene. In the preferred embodiment, the dimensions of each tray are 46″×69″ and each has a roughly 15 degree tilt. When placed on the roof, the total square footage required by the preferred embodiment is under 200 square feet. In the preferred embodiment, the total weight of the solar panel array, ballast, and mounting trays is roughly 161.5 lbs each or 7.4 lbs per sq ft.

The location of the solar panel array is suggested to be set back from the roof edge by roughly six feet. The mounting trays may be positioned such that the array will face south for maximum exposure, assuming installation in the northern hemisphere. No roof penetrations are required for the mounting trays or electrical conduit. However, if roof penetration is preferred a ¾ inch conduit and #4 ground wire should be allowed for.

In the preferred embodiment, 200 watt polycrystalline 24V panels are used. An individual panel weighs roughly 37.5 lbs and measures 56″×39″×1.77″. Each panel can be pre-wired using MC4 connectors. Open circuit voltage for each panel is 44.6 V. The short circuit current for each panel is 6.06 A.

The PV combiner panel may be located at the end of the solar panel array. It is free standing on the roof and requires no permanent attachment. The PV combiner panel may include touch-safe fuse holders for each string and be capable of supporting multiple strings. The PV combiner panel preferably uses an all-aluminum powder coated enclosure with a flip up cover, a PV negative buss bar with 14 usable openings and a chassis ground buss bar with 14 usable openings. The enclosure preferably has a NEMA 3R rating and measures roughly 4″×8″×13″.

Per NEC, rooftop terminations from the array strings should take place in the combiner panel. The negative PV array wires are preferably combined at the vertical buss bar on the left hand side of the panel. The positive PV array wires are preferably connected to individual touch-safe fuse holders. A separate ground conductor may connect the array frameworks together. Chassis grounds are preferably terminated at the right hand side buss bar.

Electrical disconnects provide isolation for the solar panels as well as the batteries and DC compressor. One disconnect isolates the solar array. It is a Heavy duty 60 amp fusible switch with a NEMA 3R rating. Another disconnect isolates the battery and 24 V compressor. It is a heavy duty 200 amp fusible switch with a NEMA 3R rating.

The preferred battery enclosure holds six group 27 deep-cycle gel-cell batteries. Each battery weighs 64 lbs and has a 86.4 amp hour rating. Within the cabinet the batteries are preferably connected in three parallel strings of two batteries connected in series. The batteries are preferably maintenance free. The electrolyte is preferably gelled to prevent stratification. This provides better protection for the battery plates and is better suited for deep cycle discharging. The gelled electrolyte also results in less required charging time. The battery enclosure is preferably made of steel with a powder coated gray finish and a lockable door.

The compressor is preferably a 24V DC compressor that weighs roughly 65 lbs. The motor is preferably a 2.2 HP series-wound motor. Such a compressor is capable of delivering 8 cfm @ 100 psi or higher, and is able to operate continuously @ 200 psi and 70 degrees. The maximum current draw at max load of such a compressor is roughly 90 amps. Although the system head pressure is vented, the compressor is able to restart under a 150 psi load. The compressor is equipped with a yellow LED that will illuminate when a low power condition exists. Should this condition occur the compressor may shut down and restart once adequate power has been restored. Those skilled in the art will understand and appreciate that these specifications and dimensions are merely illustrative, and almost limitless variations of compressors having different specifications and dimensions may be used without deviating from the spirit and the scope of the invention.

Inside floor space requirements are small. The preferred battery cabinet and compressor storage tank require roughly 15 sq ft, which is approximately 6 sq ft more than the standard compressor installation. The solar power subsystem may attach directly to an AC powered compressor platform, such as may be found in a typically warehouse or plant.

The preferred charge controller is the TriStar MPPT Charge Controller because it offers maximum energy harvest with a peak efficiency of 99%. The preferred charge controller also offers extensive networking and data logging capabilities, and the electronic design provides extremely high reliability. The preferred charge controller uses standard MODBUS protocol and Morningstar MS VIEW Software with up to 200 days of data logging. The preferred charge controller also allows for live data monitoring of system parameters.

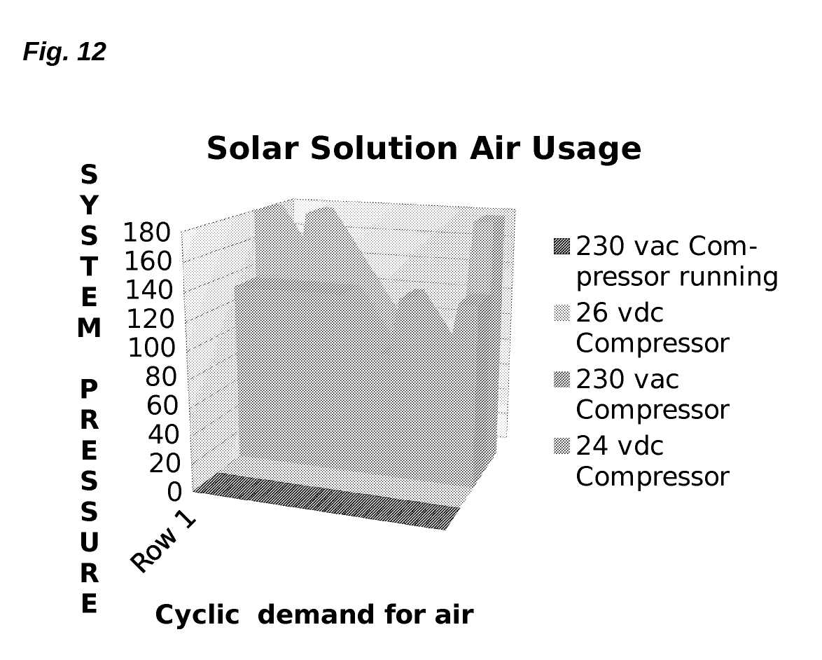

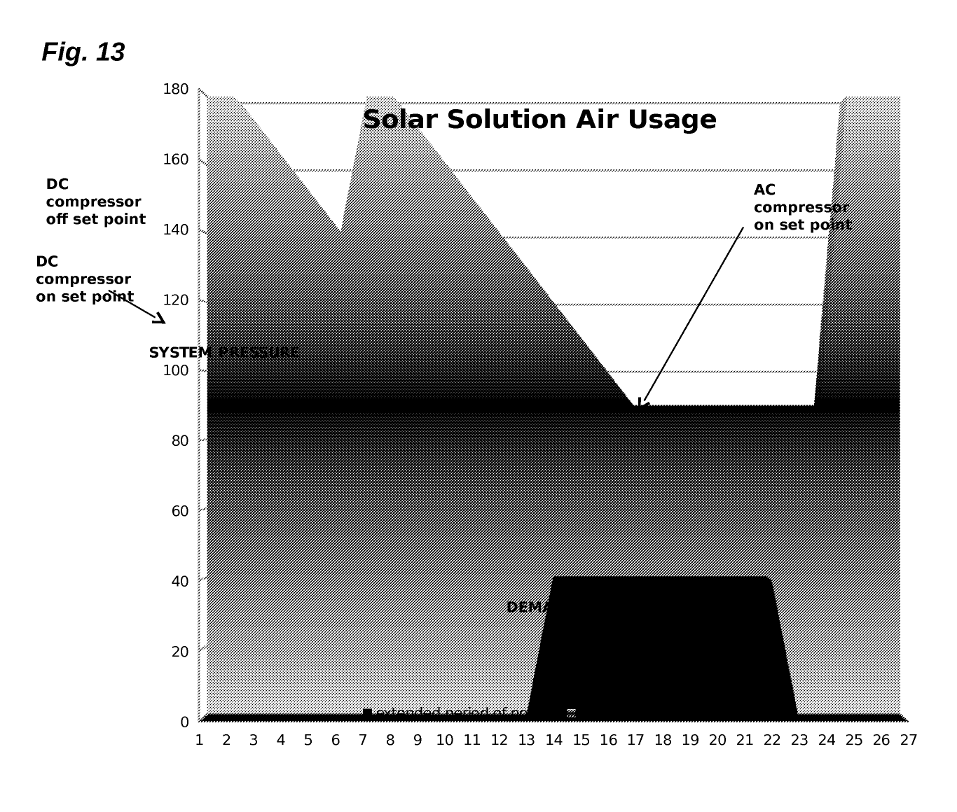

FIGS. 12 and 13 are charts showing design considerations for how the preferred 24 Vdc compressor could be configured to maintain the system requirements provided the batteries remain charged. In the event battery power is drained, an alternate compressor, such as any AC powered compressor, could maintain the system pressure requirements until the battery power can be restored.

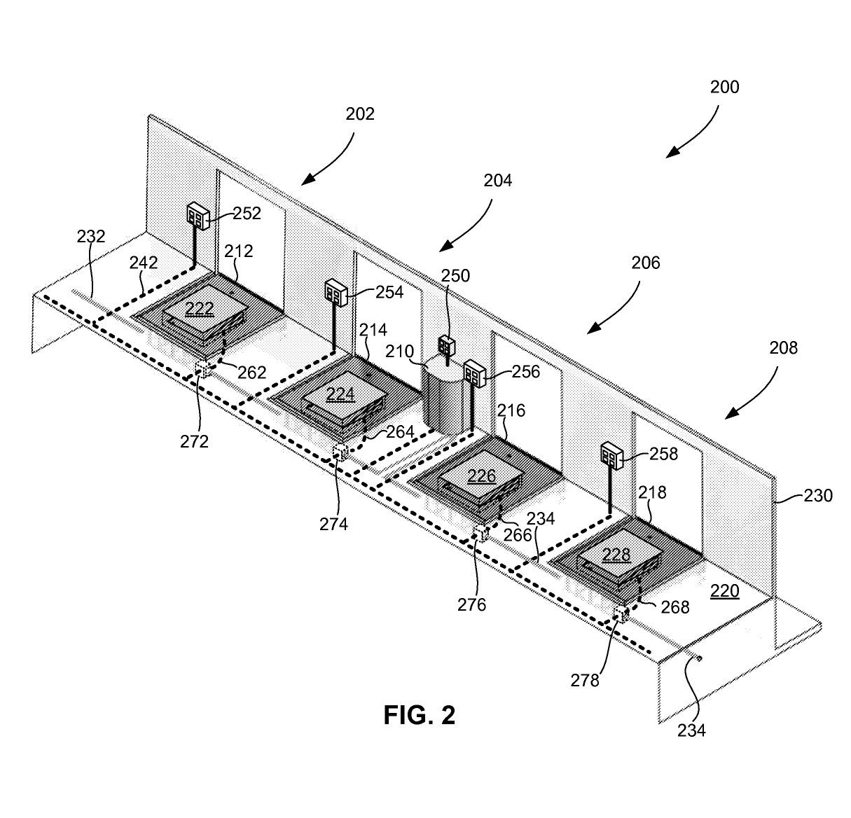

Returning now to FIG. 2, an isometric view illustrates an embodiment of a centralized air supply dock leveling system arranged in a built-in configuration. The dock leveling system 200 includes a loading dock 220 into which bay 202, bay 204, bay 206, and bay 208 are arranged. Bay 202 includes a loading dock ramp 212 that is hinged at a proximal edge. An inflatable bag 222 is arranged in a pit underneath ramp 212 so as to raise and lower a distal edge of ramp 212. A local control box 252 is provided to provide control for an operator standing adjacent to the ramp 212 to raise or lower the distal edge of the ramp 212.

Likewise, bay 204 includes a loading dock ramp 214 that is hinged at a proximal edge with an inflatable bag 224 arranged beneath ramp 214 so as to raise and lower a distal edge of ramp 214 using a local control box 254 to raise or lower the distal edge of the ramp 214; bay 206 includes a loading dock ramp 216 that is hinged at a proximal edge with an inflatable bag 226 arranged beneath ramp 216 so as to raise and lower a distal edge of ramp 216 using a local control box 256 to raise or lower the distal edge of the ramp 216; and bay 208 includes a loading dock ramp 218 that is hinged at a proximal edge with an inflatable bag 228 arranged beneath ramp 218 so as to raise and lower a distal edge of ramp 218 using a local control box 258 to raise or lower the distal edge of the ramp 218. More (or less) bays can be included (or excluded) depending on the loading dock “throughput” that is needed or anticipated by a business operating the loading dock.

The dock leveling system 200 also includes a centralized air supply 210 that is coupled to control boxes 252 and 254 via air line 232 and coupled to control 256 and 258 via air line 234. Air lines 232 and 234 can be laid beneath the surface of loading dock 220 during construction of the dock, for example. Air lines 232 and 234 can be (for example) connected to each other or commonly coupled to a common pressure chamber (e.g., air tank) using a check-valve between each air line and chamber so that a loss of air pressure in one line does not affect the second air line.

Control box 252 is a local control box that selectively couples air line 232 to air line 262 using valve 272. Air line 262 is coupled to inflatable bag 222. Control box 254 is a local control box that selectively couples air line 232 to air line 264 using valve 274. Air line 264 is coupled to inflatable bag 224. Control boxes 252 and 254 are thus arranged to respectively control the inflation of inflatable bags 222 and 224. Valves 272 and 274 may be electrically actuated, or perhaps pneumatically actuated, by control boxes 252 and 254 (respectively) to selectively open and close the valves.

Control box 256 is a local control box that selectively couples air line 234 to air line 266 using valve 276. Air line 266 is, in turn, coupled to inflatable bag 226. Control box 258 selectively couples air line 234 to air line 268 using valve 278. Air line 268 is coupled to inflatable bag 228. Control boxes 256 and 258 are thus arranged to respectively control the inflation of inflatable bags 226 and 228. Valves 276 and 278 are electrically actuated by control boxes 256 and 258 (respectively) to selectively open and close the valves.

In operation the components of dock leveling system 200 operate similarly to the corresponding components of dock leveling system 100. Dock leveling system 200 also offers an additional level of protection: because dock leveling system is built in, many (if not all) of the control and air lines lie beneath protective surfaces, which protects those components and reduces maintenance that otherwise would be required to repair damage to the components.

FIG. 3 is a schematic diagram illustrating an embodiment of a centralized air supply dock leveling system. The docking system 300 is depicted in a cross-section taken through a loading dock 302 bay. The loading dock 302 includes one or more bays as illustrated in FIG. 1 and/or FIG. 2. As shown in cross-section, ramp 304 is pivotally attached to loading dock 302 by a hinge 306 at a proximal edge. An inflatable bag 320 is arranged in a pit 308 underneath ramp 304 so as to raise and lower the distal edge of ramp 304.

A user activates controls (such as a push buttons, levers, switches, and the like) on user control 310 (for example) to raise or lower the ramp 304. The user control 310 provides a control interface to the dock leveler control unit 316 for proving commands for and receiving status indications from the dock leveler control unit 316 (for example, an “in use” indication can be used to warn operators of other bays that another ramp is being raised (which may lower available air pressure). For convenience, the user control module 310 (including the user control units from other bays) may be included in the dock leveler control unit 316 housing and electronic circuits. For example, a combined user control module 310 and dock leveler control unit 316 can be used as a master control unit for controlling all units to provide redundancy and arbitration, while other (local) control units 310 can be provided to control individual bays. The user control 310 can also be a wireless device that is hand-held.

Dock leveler control unit 316 is coupled to a bed height sensor 312 that is arranged to determine a height of a truck (or other vehicle) bed 314 for which the ramp 304 is to be adjusted. In an embodiment, bed height sensor 312 is an acoustic, optical, or radio- or microwave-frequency range finder that determines the relative distance between the top of the truck bed 314 and the bed height sensor 312. Dock leveler control unit 316 uses the position and the relative angle of the positioning of the bed height sensor 312 and the measured relative distance to determine the height of the truck bed. The bed height sensor 312 is typically located on an outside surface of the loading dock 302 in a central location over a bay door, which provides an unobstructed “view” of the truck bed 314 as the truck is backed in closely to the bay door. The bed height sensor can scan and/or nutate within the plane of the illustrated cross-section to create a time-variant electronic profile used to determine the distance and height of the back end of the truck bed 314.

Dock leveler control unit 316 is also coupled to a ramp position sensor 318 that is used to determine a height for the proximal edge of the ramp 304. In an embodiment, the ramp position sensor determines the degree of rotation (e.g., angle) of the ramp 304 about the hinge 306 to which the proximal edge of the ramp 304 is affixed. The position of the hinge 306, the angle of the ramp 304, and the distance of the proximal edge to the distal edge of the ramp 304 (as well as other factors) are used to determine the height of the distal edge of the ramp 304.

In operation, a user activates a control on user control 310 to raise the distal portion of ramp 304 above the truck. Dock leveler control unit 316 instructs air valve unit 322 to supply pressurized air to the inflatable bag 320 for raising and lowering the ramp 304. The activation of the “raise ramp” button can be a “fire and forget” command where the user depresses and releases the “raise ramp” button while the dock leveler control unit 316 continues to direct the air valve unit 322 to inflate the inflatable bag 320 until the ramp position sensor 318 indicates a safe angle of the ramp 304 to permit safe docking. The “fire and forget” command can be countermanded (canceled) by, for example, pressing a “stop” button or a “lower ramp” button on the user control.

As the truck bed approaches, the bed height sensor 312 monitors the electronic profile and the degree of rotation of the ramp 304 to determine if the proximal edge of ramp 304 is progressing past (or has progressed past) the height of the truck bed 314. If the indicated angle is not “safe,” the dock leveler control unit 306 can provide an audible/visual warning, as well as prioritize the delivery of pressurized air to the bay in the warning condition to speed the inflation of the associated inflatable bag 320.

The delivery of pressurized air to the bay in the warning condition can be accomplished by closing (e.g., turning off) valves currently being used to raise ramps in other bays, as well as to increase the current and pressure of the pressurized air. The current and pressure of the pressurized air can be increased by directing the compressor for the centralized air supply to increase the rate of air compression (such as by using a higher speed on a multi-speed motor), activating a parallel compressor, coupling an emergency high pressure supply to the air line, and the like.

After the truck bed 314 is docked, the user activates a control on the user control to lower the distal portion of ramp 304 to the truck bed. The dock leveler control unit releases pressure from air valve unit 322 (for example) to lower the distal portion of ramp 304 to the truck bed 314. The dock leveler control unit 316 can automatically stop (cutoff) the deflation of the inflatable bag 320 when the distal portion of ramp 304 is substantially lowered to the level of the truck bed 314 despite the continued application of pressure to the “lower ramp” button by the operator. The cutoff angle (or position) can be determined, for example, by the level of the truck bed 314 as determined using the bed height sensor or a contact sensor (not shown) arranged adjacent to the distal edge of ramp 304. The operator can override the automatic cutoff by releasing and re-pressing the “lower ramp” button.

The dock leveler control unit can determine the presence of an air leak (when the inflatable bag 320 is in a pressurized state) by monitoring the angle of ramp 304 and the pressure of the inflatable bag 320 by reading air pressure sensor 324. For example, when the angle of ramp 304 does not change substantially (such as when resting upon truck bed 314) and the pressure decreases in inflatable bag 320. The dock leveler control unit can notify the user (through the user control 310, for example) of the presence of the leak and in which bay the leak occurs.

When the material handlers have finished loading and/or unloading truck bed 314, the operator can depress the “raise ramp” button (as described above) to raise the distal portion of the ramp 304 to free the surface of the truck bed 314 from the distal edge of ramp 304. After the vehicle of truck bed 314 departs, the user can press the “lower ramp” button to lower the distal portion of the ramp 304 to a neutral position such as indicated by an angle of 0 (zero) degrees relative to the plane of the loading dock 302 surface.

Cylinder 330 is optionally provided in conjunction with the inflatable bag 320 and is arranged to function as a braking device in the event the support device for the dock leveler is removed unexpectedly (e.g., such as when a truck upon which the distal portion of ramp 304 is supported departs before the ramp is raised). Cylinder 330 is typically mounted beneath ramp 304 having a upper portion that is rotatably affixed to a distal portion of ramp 304 and a lower portion that is rotatably affixed to a surface of pit 308 (other arrangements are possible).

Clutch unit 334 is (optionally) arranged on the upper portion of cylinder 330 and is activated to impede the linear travel of piston 332 (of the upper portion of cylinder 330) to slow the acceleration of the piston 332 when ramp 304 is suddenly lowered. Clutch unit 334 can be activated in response to changes in air pressure detected, for example, in piston 332, in inflatable bag 320 (via pressure sensor 324), in air valve unit 322, and/or valve 346 (discussed below). Valve 346 is arranged to operate in conjunction with (or independently of) of an optional air pressure relief valve (not shown) in air valve unit 322. In an embodiment, a user may use pull chain 340 to actuate valve 346 via a mechanical force transferred to the valve 346 via pulleys 342 and cable 344. The mechanical force may be opposed by an opposing force provided by, for example, a spring that is compressed or tensioned in response to a user pulling on the pull chain 340. The opposing force can be used to close the air pressure relief valve, or to latch the pressure valve 346 in an open state until a subsequent pull of the pull chain 340 releases a latching mechanism so that the pressure valve 346 returns to a closed state. Mechanical controls (such as pull chain 340) can be also used to control the inflation of air bag 320 by selectively opening a valve in the air valve unit 322 to couple the pressurized air supply to the air bag 320.

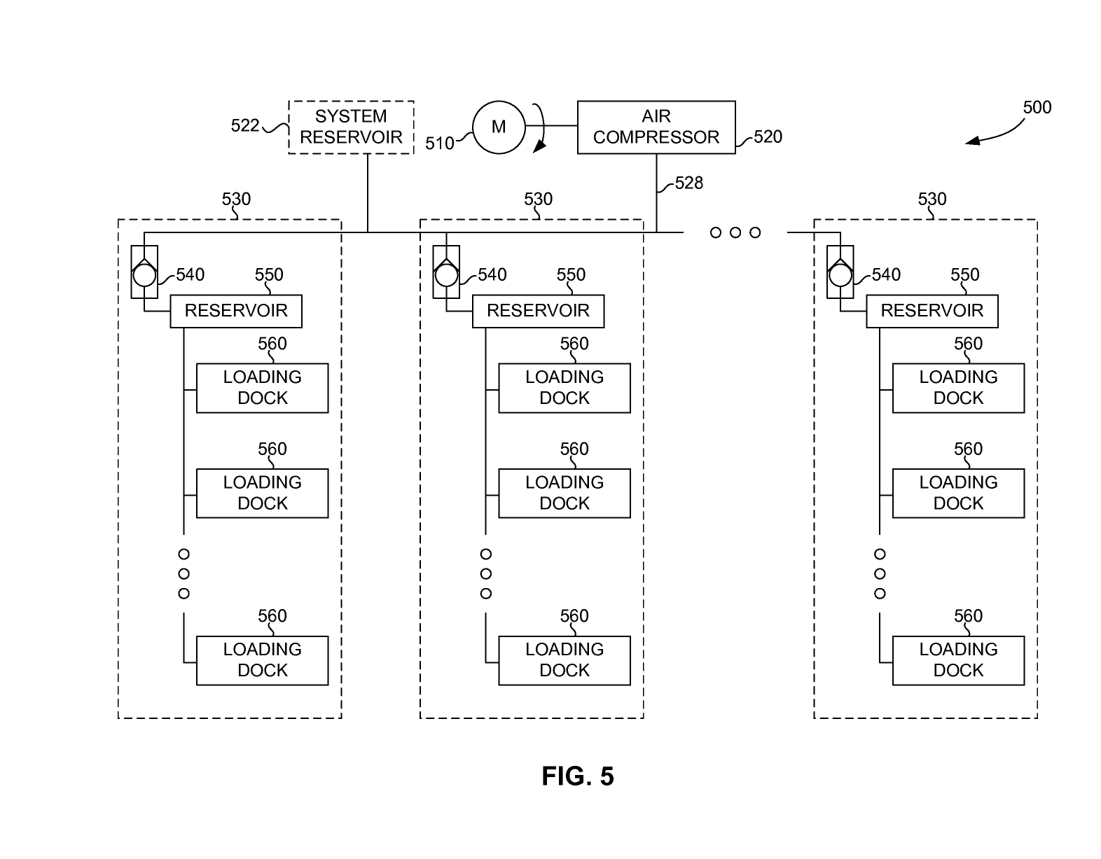

Using mechanical controls (in conjunction with or in replacement of components such as electrical control mechanisms such as dock leveler control unit 316) allows the system to operate when the loss of electrical power (including flooding or rain-storm conditions when application of electrical power poses a hazard to human life or health) is encountered. The mechanical controls can thus continue to operate when a portion of at least one loading dock is submerged in water, for example, by storing pressurized air (as discussed below with respect to FIG. 5 in the optional system reservoir 522).

The stored pressurized air is selectively coupled to the inflatable air bag 320 in response to a user manipulating (including other intentional mechanical motivations) a mechanically actuated linkage that is arranged to inflate and/or deflate the inflatable air bag 320. Additionally, the use of pneumatic systems alleviates special handling procedures and expenses associated with using and cleaning hydraulic systems and the potential of environmental harm resulting from escape of the hydraulic fluid to the environment.

In an embodiment, the pressure valve 346 includes an air velocity fuse for detecting a relatively high flow rate of air (such as might be expected when a truck suddenly departs with the ramp 304 in a lowered position). In a situation where pressure valve 346 is latched in an open state, the air velocity fuse is arranged to detect the high flow rate of air and, in response to the detection of the high flow rate of air, to block and/or limit the flow of air from the inflatable bag 320. For example, the high flow rate of air can be used to close a check valve that resets automatically when the flow rate of air decreases below a threshold (the rate of air flow at which the check valve resets may be set below the threshold of the high flow rate of air used to block the flow of air).

Restraint 350 is selectively coupled to the pressurized air supply and is arranged to restrain, for example, a truck having a bed 314 that is supporting (and/or partially supporting) ramp 304 (which then prevents an inattentive driver from driving the truck away while the bed 314 is still supporting the ramp 304). Restraint 350 is arranged to engage and disengage from a locking station 352 (such as a rear impact guard) of the truck. Restraint 350 is selectively coupled to the pressurized air supply, for example, in response to a command (and/or a sequence of commands) by a human operator. Restraint 350 can be mounted on an outside wall of loading dock 302 and/or a surface of pit 308.

A first command from a user is given to “lock” in place the vehicle supporting bed 314 (after the truck is appropriately situated at loading dock 302, for example) selectively couples (e.g., applies, removes, and/or relieves) pressurized air from the pressurized air supply to the restraint 350, which causes the restraint 350 to engage the locking station 352 (thus “locking” the vehicle). Using the restraint 350 to engage the locking station helps prevent an premature departure of the vehicle, and secures the bed 352 from moving away from the loading dock 302, for example, in response to forces encountered while handling material on bed 314 (including braking forces exerted by fork-lift machines).

A second command from a user is given to “unlock” the vehicle (such as when the task of loading and/or unloading the bed 314 of the truck has been completed and the truck is ready for departure). The second command selectively couples (e.g., applies, removes, and/or relieves) pressurized air from the pressurized air supply to the restraint 350, which causes the restraint 350 to disengage the locking station 352 (thus “unlocking” the vehicle).

In an alternate embodiment, a release of pressurized air is used to cause the restraint 350 to engage the locking station 352 (for example, by releasing pressurized air to selectively move a locking arm in opposition to a stored force such as a spring), and application of pressurized air is used to cause the restraint 350 to disengage the locking station 352 (for example, by applying pressurized air to selectively move a locking arm in accordance with a stored force such as a spring).

In yet another embodiment, the command to cause the restraint 350 to disengage the locking station 352 is generated in response to a command to pressurize the inflatable bag 320 (such as when raising the distal portion of ramp 304 to either allow a vehicle to approach or depart from a docked position where the distal portion of ramp 304 rests upon bed 314. Further, the command to engage the locking station 352 is generated in response to a command to depressurize the inflatable bag 320 (such as when the distal portion of ramp 304 is to be lowered to rest upon the bed 314 or after the vehicle supporting bed 314 has departed).

Pressurized air station 360 is provided in a location convenient to a user (such as upon the interior or exterior surface of the wall of loading dock 302) to be used for maintenance of the loading dock 320 and associated elements. For example, a user can (removeably) attach an air hose (not shown) to a user-accessible fitting 362 for the purpose of using compressed air to clean debris from pit 308. Fitting 362 can be located at a location adjacent to one or more loading docks 302 wherein the attached air hose is of sufficient length to reach the adjacent loading dock 302.

Using compressed air from pressurized air station 360 to remove of debris from pit 308 is facilitated because the fitting 362 can be conveniently coupled to air lines that, for example, are routed to the pit 308 for the purpose of inflating the inflatable air bag 320. Use of a hand-tool (not shown) such as an air wand (attached to a distal portion of an air hose having a proximal portion attached to the fitting 362) to deliver pressurized air for removal of debris (such as dirt, paper products, and leaves) allows a pressurized air stream to be directed towards difficult-to-reach portions of the pit 308 that exist when the pit 308 is populated with the illustrated elements (such as ramp 304, inflatable air bag 320, air valve unit 322, and cylinder 330).

Further, a user can (removeably) attach an air pressure gauge to the fitting 362 to manually read the air pressure of the pressured air system at location of the loading dock 302 for conveniently performing maintenance and trouble-shooting procedures. Fitting 362 is optionally a quick-release, check-valve fitting to allow for convenient coupling (and decoupling) of attachments, and to minimize the escape of pressurized air while coupling and decoupling attachments to the fitting 362.

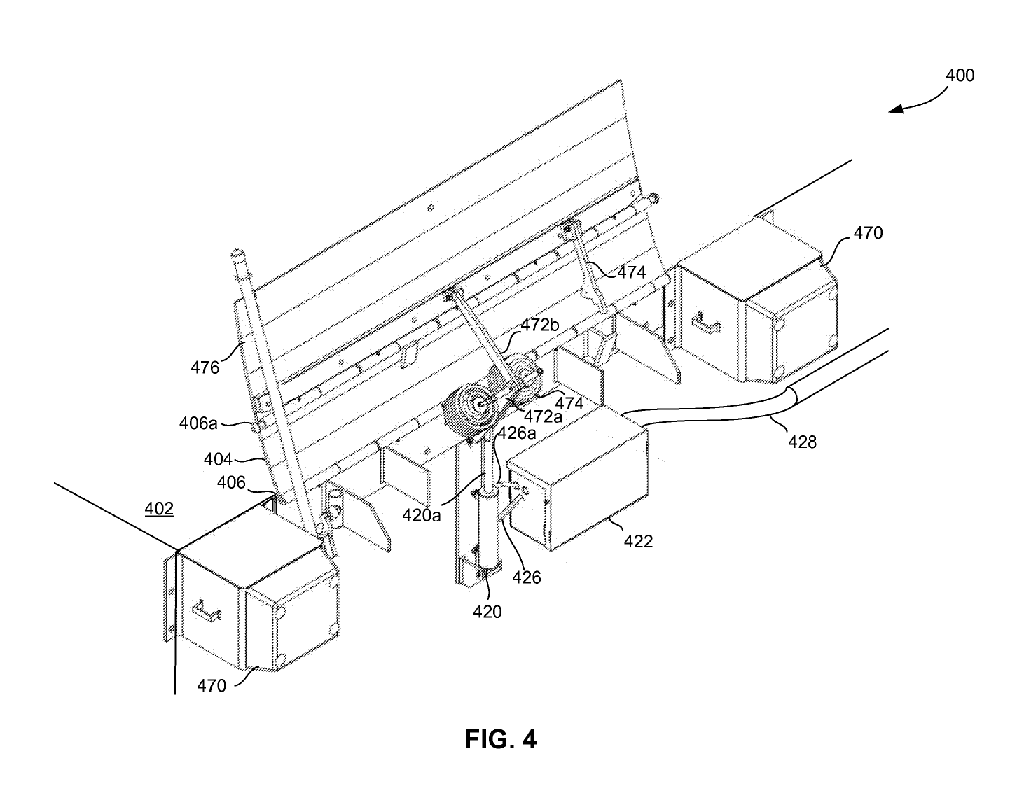

FIG. 4 is a schematic diagram illustrating an embodiment of a pneumatic edge-of-dock leveler of a dock leveling system. The edge-of-dock leveler 400 is illustrated in isometric view and is arranged adjacently to an outer surface of loading dock 402 floor. The loading dock 402 includes a dock edge along which hinge 406 is arranged. Hinge 406 operates in conjunction with (or independently of) hinge 406a to lower or raise a loading ramp that includes lip plate 476 and center plate 404.

Air valve unit 422 (operating under control of a control unit such as user control unit 310) is arranged to selectively apply (e.g., couple) pressurized air from a pressurized air supply line 428 to pneumatic cylinder 420. Pneumatic cylinder 420 is arranged to (for example) extend piston arm 420a in a generally upwards direction when pressurized air is applied via air hose 426 and to retract piston arm 420a in a generally downwards direction when pressurized air is applied via air hose 426a.

Center plate 404 and lip plate 476 are illustrated in a “stored,” upright position, which allows, for example, a truck to drive in reverse into bumper blocks 470 for the purpose of loading and/or unloading materiel from the bed of the truck. When the truck is properly docked, the distal edge of lip plate 476 is lowered by retracting piston arm 420a. Piston arm 420a is mechanically coupled to spring assembly 474 and lifting arm(s) 472a and 472b and lowers the distal edge of lip plate 476 as the piston arm 420a is being retracted. Extended link arm 474 is arranged to provide a mechanical stop to limit the downwards movement of the lip plate 476.

In an alternate embodiment, a relief valve (such as valve 346) coupled to pneumatic cylinder 420 can be used in place of air hose 426a. The relief valve can be opened to allow the mass of the center plate 404 and lip plate 476 to urge the ramp in a generally downwards direction under gravitational forces.

Center plate 404 and lip plate 476 are raised, for example, to allow a truck to depart from dock 402 after loading and/or unloading. Before the truck is allowed to depart, the distal edge of lip plate 476 is raised by extending piston arm 420a. Extending piston arm 420a raises the spring assembly 474 and lifting arm 472a and 472b, which raises the lip plate 476 and center plate 404 to the stored, upright position. The upwards extent of the travel of the piston arm 420a can be used to limit the degree to which the center plate 404 and lip plate 476 can be raised.

FIG. 5 is a schematic diagram illustrating an embodiment of a distributed reservoir of a centralized air supply dock leveling system. Distributed reservoir system 500 includes a motor 510, and air compressor 520, and one or more distribution branches 530, each of which includes a check valve 540, a reservoir 550, and one or more loading docks 560.

Motor 510 is adapted to drive air compressor 520 and is typically electrically powered, although energy derived from fuel, steam, water, wind, animal-power, and the like can be used to drive the air compressor 520. In a situation where the use of electrical power is to be avoided (such as flooding, or when potentially explosive vapors might be encountered), the motor can be selected and/or positioned to avoid hazardous situations. Thus, for example, the motor and air compressor can be provided in a location that is away from the loading docks 560 and/or associated reservoirs 550. In such a situation, compressed air can be safely delivered to the loading docks 560 via air lines 528.

Motor 510 is selected to drive air compressor 520 to gradually pressurize the reservoirs 550 of the branches 530 of the distributed reservoir system 500. Thus, motor 510 (and compressor 520) need not be required to instantaneously provide compressed air sufficient to simultaneously supply the needs of one, two, or more branches of the distributed reservoir system 500. Accordingly, a relatively small-sized motor can be used to provide for a relatively large system when the aggregate usage (such as during a daily period) does not exceed the ability of the distributed reservoir system 500 to generate and/or store the compressed air in advance of the (peak) usage.

Use of the small-sized motor for all of the branches 530, for example, lowers acquisition and maintenance costs. Use of the small-sized motor also reduces the amperage of instantaneous current draw that would otherwise be encountered if each loading dock 560 were to be driven by an air compressor located at each loading dock 560.

Check valves 540 are used to partially isolate each branch 530 from other branches 530, as well as to allow pressurized air to pressurize the reservoir 550 of the associated branch. Thus, the respective reservoirs 550 of each branch 530 can be (relatively) gradually pressurized at the same time to reach the pressure capacity of each reservoir 550 (safely valves, not shown, are used to avoid over-pressurization of the reservoir 550 and other pressurized components). When usage of the compressed air stored in reservoir 550 occurs, the pressurized air can be replaced when the air pressure of the air lines 528 is higher than the pressure of the reservoir 550.

The check valves 540 also are arranged to prevent a “backwards” escape of pressurized air stored in the reservoir 550 towards the air compressor 520. When for example, the motor is disabled (such as during a hazardous condition) or does not have sufficient capacity to cause the air compressor to develop an air pressure that is greater than the pressure of the branch 530 in which the check valve 540 is arranged, the check valve 540 remains closed (which prevents the escape of air through the check valve 540). When the pressures of the system reservoir 522 reaches or exceeds the pressure of a local reservoir 550, the check valve 540 to the local reservoir 550 is opened, which allows the local reservoir 550 to become more highly pressurized.

Reservoir 550 is selected to have sufficient capacity to provide compressed air in accordance with the expected usage of compressed air to the one or more loading docks 560 of the respective (associated) branch 530. The reservoir 550 is one or more storage tanks that, optionally, function as a single storage tank. Thus, the usage of compressed air for a loading dock 560 (such as raising a ramp 304, providing air to (automatic vehicle) restraint 350, and supplying air for pressurized air station 360) is provided by reservoir 550, which in turn is gradually recharged by air compressor 520.

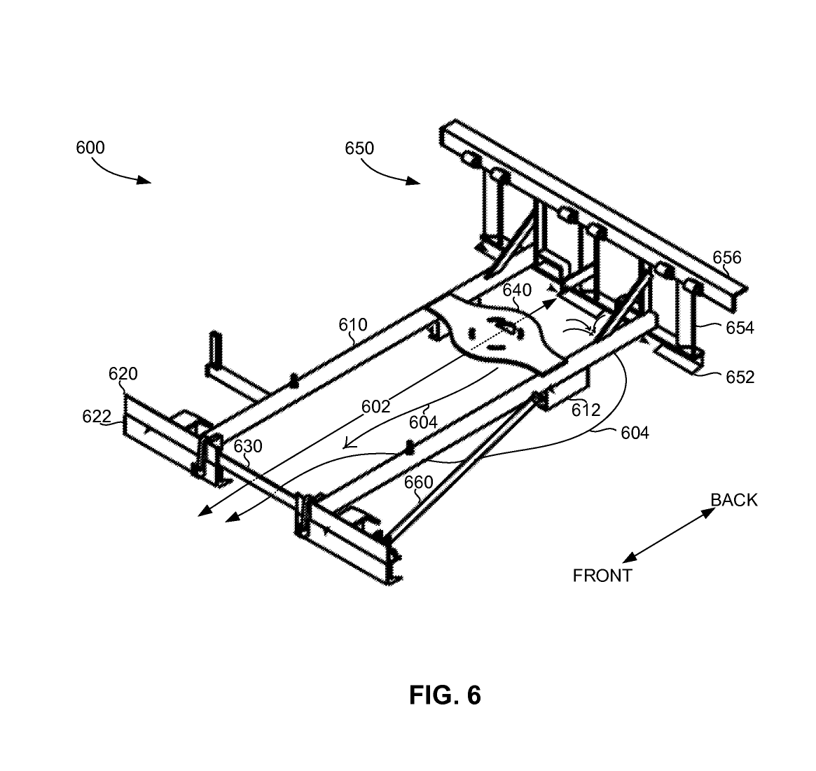

FIG. 6 is a frontal isometric view illustrating an embodiment of a self-cleaning dock leveling system frame. Frame 600 is arranged to fit within a loading dock pit such as pit 308. Frame 600 includes longitudinal frame sections 610 that are coupled to transverse front frame members 620 and a transverse back frame member 650. The longitudinal frame sections 610 are arranged to support a transverse bellows platform 640 such that a central channel 602 is formed beneath the transverse bellows platform 640.

System reservoir 522 can optionally be used to provide a supplemental and/or back-up (e.g., emergency) source of air in the event(s), for example, of the air compressor being unavailable, and/or the peak usage requirements of the (combined) loading docks. The capacity of System reservoir 522 can be selected to provide sufficient pressurized air so that the loading docks 560 can, for example, operate for a time that is estimated to be sufficient for power to be restored to the motor 510.

The central channel 602 is arranged having dimensions (such as a vertical clearance between the lower surface of a loading dock pit in which the frame 600 is arranged and the lower surface of a middle portion of the transverse bellow platform 640) that are sufficient to permit the relatively free passage through the central channel of debris (such as dirt, paper products, and leaves) that are pushed along by a channeled flow 604 of compressed air exhausted into the loading dock pit. The channeled flow 604 of exhausted compressed air is generally channeled into the central channel 602. Although the channeled flow 604 is not completely restricted to a horizontal direction, the debris that is pushed along by the channeled flow 604 is generally captivated by gravity, and thus the debris tends to remain (or settle) at or near the bottom surface of the loading dock pit.

The central channel 602 extends longitudinally forward underneath an optional removable frame section 630 that is supported by adjacent front frame members 620. The vertical clearance of the central channel is typically sufficient to permit the relatively free passage of air current-motivated debris underneath the bottom portion of the removable frame 630. When the vertical clearance (if any) underneath the bottom portion of the removable frame 630 is insufficient to permit the relatively free passage of debris, the removable frame section 630 can be removed so as to allow unimpeded egress of, access to, or both unimpeded egress of and access to the debris.

Frame 600 is supported, for example, by supports 612, 622, and 652 that are in turn supported by the lower surface of a loading dock pit in which the frame 600 is arranged. Supports 622, 612, and 652 are arranged to respectively support the longitudinal frame sections 610, the front frame members 620, and the transverse back frame member 650. The transverse back frame member 650 includes vertical support members 654 that are arranged to support a rear angle frame member 656. The rear angle frame member 656 is arranged to engage an upper, rear portion of the loading dock pit such that the rear lip of the rear angle frame member 656 rests on top of or flush with the surface of the loading dock floor.

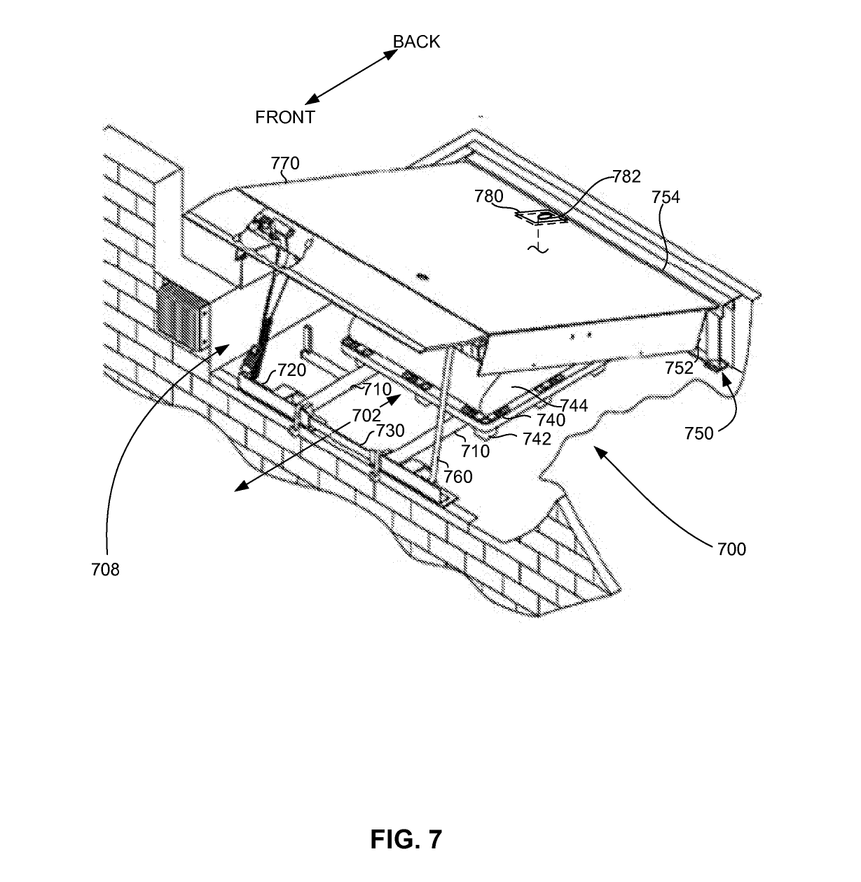

Maintenance prop 660 is shown in a storage (unused) position. The maintenance prop 660 is used to mechanically secure (when arranged in an upright position) a loading dock ramp in an extended position when performing maintenance (as illustrated in FIG. 7 below), for example. The storage position of maintenance prop 660 typically provides sufficient vertical clearance (above the floor of the loading dock pit, for example) for the unimpeded flow of air-current motivated debris.

FIG. 7 is a frontal isometric view illustrating an embodiment of a self-cleaning dock leveling frame and system. Frame 700 is arranged to fit within a loading dock pit 708. Frame 700 includes longitudinal frame sections 710 that are coupled to transverse front frame members 720 and a transverse back frame member 750 (which is arranged along back wall 752). The back wall 752 is subjacent (e.g., underneath and adjacent) to hinge 754, which is arranged at a proximal end of loading dock platform (ramp) 770. The longitudinal frame sections 710 are arranged to support (or traverse underneath) a transverse bellows platform 740 such that a central channel 702 is formed beneath the transverse bellows platform 740. The central channel 702 is arranged having dimensions that are sufficient to permit the relatively free passage through the central channel of debris (such as dirt, paper products, and leaves) that are pushed along outwards from the loading dock pit 708 by a channeled flow of compressed air exhausted into the loading dock pit 708.

The central channel 702 extends (from under the transverse bellows platform 740) longitudinally forward underneath an optional removable frame section 730 that is supported by adjacent front frame members 720. The vertical clearance of the central channel is typically sufficient to permit the relatively free passage of air current-motivated debris underneath the bottom portion of the removable frame 730. When the vertical clearance (if any) underneath the bottom portion of the removable frame 730 is insufficient to permit the relatively free passage of debris, the removable frame section 730 can be removed so as to allow unimpeded egress of, access to, or both unimpeded egress of and access to the debris.

Frame 700 is supported, for example, by support members (not shown, for clarity: see, e.g., 612, 622, and 652) that are in turn supported by the lower surface of a loading dock pit in which the frame 700 is arranged. Supports 742 are optionally arranged to support the transverse bellows platform 740 (such that the transverse bellows platform 740 can be supported by the longitudinal frame sections 710, the supports 742, or both the longitudinal frame sections 710 and the supports 742).

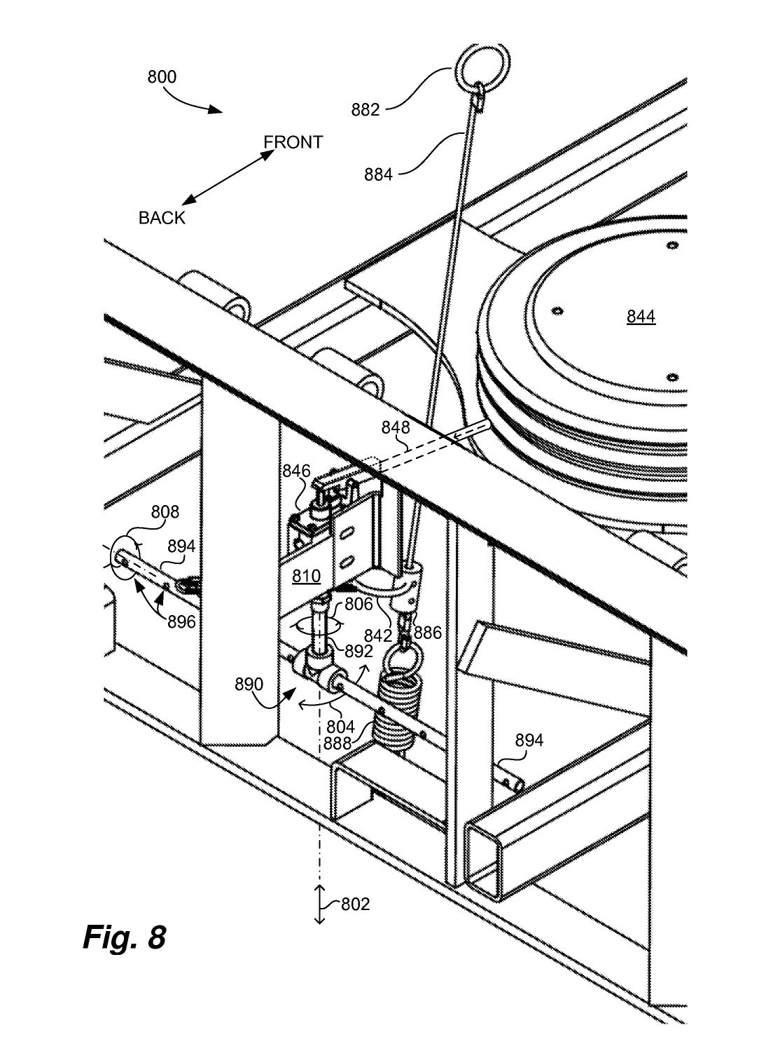

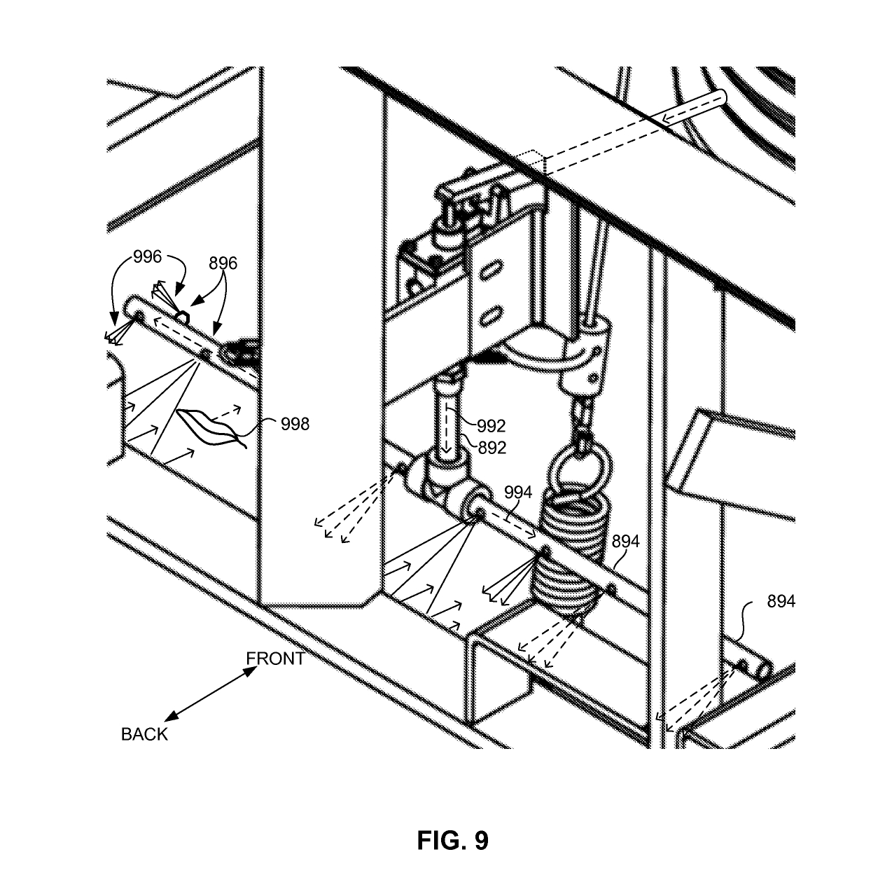

A loading dock platform (ramp) 770 is pivotally coupled to the transverse back frame member 750 using a hinge 754, which permits the loading dock platform 770 to be raised and lowered by the (rectangular) bellows 744. A pull ring 782 is adapted to be grasped by an operator and is stored in a recess 780. The pull ring 782 is coupled to a pull chain and/or lanyard that allows an operator to open a bellows exhaust valve (that is typically adjacent to the bellows 744 below the loading dock platform 770) to lower the loading dock platform 770 (by exhausting compressed air stored in the bellows 744, for example). As described below in FIG. 8 and FIG. 9, the compressed air is directionally exhausted through a manifold, which generates flows of channeled air (such as channeled flow 604) that is used to clean the loading dock pit 708 of debris (that, for example, would otherwise accumulate and require longer maintenance periods for potentially hazardous manual cleaning of the debris where a maintenance person enters the loading dock pit 708 underneath of the raised loading dock platform 770).

Maintenance prop 760 is shown in an upright (used) position. The maintenance prop 760 is used to mechanically secure (when arranged in an upright position) the loading dock platform 770 in an extended position when performing maintenance (as illustrated in FIG. 7 below), for example. Mechanically securing the loading dock platform 770 increases the safety margin for maintenance technicians that perform maintenance underneath of the loading dock platform 770.

FIG. 8 is a rear isometric view illustrating an embodiment of a self-cleaning dock leveling frame and system. System 800 is arranged to fit within a loading dock pit 708 (such as a loading dock pit 708) and is illustrated using a point of view above and behind the back of the pit. (The rear wall of the pit is not explicitly shown for purposes of clarity.) System 800 includes a cylindrical (although rectangular bellows such as bellows 744 can be used) bellows 844, which uses compressed air to inflate the bellows 844 such that a ramp (such as loading platform 770) is raised. As discussed above (also with reference to FIG. 3, for example), the compressed air in the bellows can be selectively exhausted in response to actuation of a user control, such as a pull chain.

System 800 includes a pull ring 882 that is attached to a lanyard 884 (such as a cable or a chain) that is coupled to a weight 886 and a snubber spring 888 arranged to aid in the retraction of the lanyard 884, relieve stress on control valve 846 and linkage 842, supply a force that (in the absence of an opposite, superior force) is sufficient to close the control valve 846, and to provide tactile feedback (and to provide an opposing force) to an operator pulling on lanyard 884 (which tends to open the control valve 846 in proportion to the force applied by the operator).

When an operator pulls on the pull ring 882, the lanyard 884 is translated in a generally upwards (opposing the gravitational force resulting from weight 886 and the snubber spring 888 force) direction, which actuates linkage 842 in a direction that is arranged to open control valve 846. Compressed air (having been previously used to raise the loading dock platform) from bellows 844 is coupled via air line 848 to an input of control valve 846. When the control valve 846 is opened (including the meaning of “partially” opened), compressed air from bellows 844 flows through control valve 846 and is coupled into exhaust manifold 890. Exhaust manifold 890 is arranged to directionally exhaust the coupled compressed air using apertures (such as apertures 896) through a manifold to generate a flow of channeled air that is used to clean the loading dock pit (as described below with reference to FIG. 9).

When an operator releases the pull ring 882, the lanyard 884 is translated in a generally downwards (in accordance with the gravitational force resulting from weight 886 and the snubber spring 888 force) direction, which actuates linkage 842 in a direction that is arranged to close control valve 846. When the control valve 846 is closed, compressed air from bellows 844 is blocked from flowing through control valve 846 (and is thus decoupled from exhaust manifold 890). Control valve 846 can be closed before the pressure of the (compressed) air in bellows 844 is reduced to, for example, ambient pressure. The force applied by the weight 886 and the snubber spring 888 can “urge” the pull ring 884 to be “self-stored” with a retracted storage position, such as illustrated by recess 780.

Exhaust manifold 890 includes, for example, a down-tube 806 that is coupled to manifold arms 894. Manifold arm(s) 894 include an array of one or more apertures (such as apertures 896) through with the selectively coupled compressed air is exhausted. The apertures 896 are orifices that are each arranged to directionally emit a focused stream of compressed air. Thus the apertures can be holes, nozzles, slots, vent, and the like that maintain a high pressure (and attain a relatively high velocity) as the compressed air is exhausted. One or more of the orifices can be oriented such that compressed air from a plurality of the orifices is independently directed with respect to the direction in which other orifices emit respectively focused streams of compressed air.

The exhaust manifold 890 is adjustably secured such that the location and orientation of the apertures can optimally positioned and angled to “sweep” (using air currents as described below with reference to FIG. 9) debris in accordance with the type of debris encountered in a particular application. For example, sweeping of denser objects including rocks, coins, bolts, nuts, and the like may require a closer positioning of the manifold arms to the back wall of the loading dock pit, to at least partly move such debris, while sweeping of less-dense objects including leaves, cigarette butts, candy wrappers, and the like may require a different setting for optimal sweeping (depending on the physical arrangement of the particular loading dock pit and pressure/volume of compressed air available from the bellows 844).

For example, the manifold arms 894 can be rotated about their longitudinal axis (as illustrated by rotation 808) to selectively control the angle (and position) of the compressed air streams emitted from the manifold arms 894. Likewise the manifold 890 can be rotated about the vertical axis of down-tube 892 (in accordance with rotation 806). The down-tube 892 can be pivotably affixed at a proximal end such that a distal end (e.g., the manifold arms 894) can be adjusted (e.g., swung) in accordance with arc 804. Additionally the down-tube 892 can be a telescopically adjusted (e.g., along axis 802) and secured using a collet to, for example, control the height of the manifold arms 894 (e.g., having a distance that is adjusted lengthwise along an axis 802 that is defined by the degree of the swing along arc 804). Mounting bracket 810 can be adjusted, for example, by rotation about an axis that extends front-to-back through the mounting bracket 810 (e.g., providing a fifth degree of adjustment freedom) to orient (and secure) the control valve 846 and the manifold 890 assembly such that the manifold arms 894 maintain an even spacing from the floor (for example, where the floor of the pit is sloped left-to-right).

FIG. 9 is a rear isometric view illustrating operation of a self-cleaning dock leveling frame and system. When the control valve 846 is opened (in response to an action by an operator, such as a pull ring 882 being pulled), compressed air from bellows 844 (which supports a loading platform ramp to be lowered) flows through control valve 846 and is coupled into exhaust manifold 890. Exhaust manifold 890 is arranged to directionally exhaust the coupled compressed air (as exhaust 996) using apertures (such as apertures 896) through a manifold to generate a flow of channeled air that is used to clean the loading dock pit.

The exhaust 996 of exhaust manifold 890 can be selectively directionally exhausted, for example, as directed jets of air by an operator selectively adjusting portions of the exhaust manifold (such as described above with respect to FIG. 8). For example, the user can install (or plug) selected ports, orifices, nozzles, and the like of manifold arms 894, or combinations thereof. The nozzles can be selected to provide a desired “spray” (e.g., dispersal) pattern, such as a narrow cone, a broad cone, a “fan” pattern, a “curtain” pattern, and the like. The nozzles can be placed and oriented such that the directed jets of air are focused on specific hard-to-reach areas (e.g., to facilitate cleaning of the hard-to-reach areas).

The arrangement of apertures 896 need not be uniform such that the apertures 896 exhaust air in a uniform direction. For example, the apertures 896 can be arranged so that exhaust air is both simultaneously exhausted towards the front of the loading dock pit as well as towards a back wall. The exhaust 996 directed towards a back wall (e.g., 752) can be directed to impinge a surface of the back wall such that the direction of the air is reversed and reflected forwards (towards the front of the pit) and downwards to the floor of the loading dock pit such that debris 998 is moved forward towards (and possibly ejected from) the front of the loading dock pit.

Thus, no extra energy need be consumed to automatically sweep debris from the loading dock pit (because, for example, energy stored in raising the loading dock ramp is used to generate the streams of channeled air as the loading dock ramp is lowered). Even when the power of the exhaust 996 is insufficient to remove the debris 998 from the floor (or other members of the dock-leveling system), the movement of the debris 998 to easier-to-clean areas shortens maintenance times and reduces risks associated with encroaching potentially hazardous areas of the loading dock pit by personnel, tool, cleaning agents and the like. Accordingly, normal use of the self-cleaning dock leveling system, where the ramp is repeatedly raised and lowered, provides successions of air currents that progressively sweep debris (that would otherwise accumulate) either out of the loading dock pit, or into areas that are more easily, and more safely, cleaned.

Although an exemplary embodiment has been illustrated and described in this disclosure, it will be appreciated that various changes can be made therein without departing from the spirit and scope of the following claims.

The invention is:

1. An inflatable-bellows dock leveling system, comprising:
an inflatable bellows arranged to raise and lower a distal portion of a loading dock ramp in response to the degree to which the inflatable bellows is inflated with compressed air;
a control valve coupled to the inflatable bellows, wherein the control valve is arranged to selectively switch between a neutral position and an activated position, and further wherein the control valve is configured to release compressed air from the inflatable bellows in the neutral position and is configured to allow the compressed air to inflate the inflatable bellows in the activated position;
an exhaust manifold arranged to receive the selectively released compressed air from the control valve and to directionally exhaust a focused stream of compressed air; and
a solar powered subsystem configured to store solar energy in at least one battery, and to use the stored energy to power a compressor that provides the compressed air to the inflatable bellows.
